(19) United States
(12) Patent Application Publication
(10) Pub. No.: US 2026/0048995 A1
(43) Pub. Date: Feb. 19, 2026

(54) METHOD FOR MANUFACTURING NANO METAL OXIDES AND HYDROGEN

(71) Applicant: trueECO Technology INC., Kaohsiung City (TW)

(72) Inventors: CHENG-JYE CHU, Kaohsiung City (TW); YI-JIA CHU, Kaohsiung City (TW); YI-CHEN CHU, Kaohsiung City (TW)

(21) Appl. No.: 19/192,398

(22) Filed: Apr. 29, 2025

(30) Foreign Application Priority Data
Aug. 15, 2024 (TW) 113130684

(51) Int. Cl. C01F 7/30; C01B 3/32

(52) U.S. Cl. CPC C01F 7/30; C01B 3/323; C01B 2203/02

(57) ABSTRACT

A method for manufacturing nano metal oxides and hydrogen includes the following steps: Step A, providing a first reactor, and placing a metal material, an alcohol compound, and a first catalyst in the first reactor and applying heating thereto for reacting to generate a metal alkoxide compound, while simultaneously generating a substantial amount of hydrogen; and Step B, providing a second reactor, and, after the metal material in the first reactor has fully reacted in Step A, transferring remaining solution in the first reactor into the second reactor, and adding a second catalyst and a controlled amount of water, and applying appropriate heating to generate nano metal oxide in powder form. As such, effects of significant reduction of production cost, enhancement of safety, widespread application of hydrogen fuel cells, extremely low carbon emissions, being defined as “green hydrogen”, and reduction of storage costs and risks can be achieved.

### BACKGROUND OF THE INVENTION

### (a) Technical Field of the Invention

The present invention relates generally to the production of hydrogen, and more particularly to a method for manufacturing nano metal oxides and hydrogen.

### (b) Description of the Prior Art

Hydrogen is one of the most abundant elements on Earth, but it cannot exist stably in its elemental state. Usually, hydrogen must be converted into water molecules to exist in a stable state. When hydrogen burns, it only produces clean pure water without emitting any exhaust gas. Therefore, hydrogen has become one of the most promising alternatives to fossil fuels in recent years. Around the world, many advanced industrial countries now view hydrogen as an important green energy source of the future and have been developing various sustainable ways for hydrogen production. Hydrogen production is not only an industrial technology that has been in use for many years, but also has a wide range of applications. In addition to being used to generate electricity, hydrogen can also be used in the field of energy storage, including hydrogen fuel cell vehicles and hydrogen heating, to play an extremely important role in the course of energy transition.

Although hydrogen is the lightest and most abundant element known in nature, it cannot be used directly. Usually, hydrogen must be separated from the state of being bonded with oxygen, carbon and other atoms before it can be used industrially. Currently, about 95% of hydrogen energy comes from fossil fuels. After steam reforming, the mixture of steam and methane is brought into contact with a nickel catalyst under high pressure to then produce gases including hydrogen, carbon monoxide, and carbon dioxide.

As early as the 1970s, the academic community had developed a method of photocatalytic hydrogen production. With titanium dioxide (TiO₂) photocatalyst, sunlight and ultraviolet light can cause decomposition of water so as to produce hydrogen and oxygen. Hydrogen can also be used in fuel cells. However, the hydrogen production by titanium dioxide is too low to meet the requirements of industrialization. If the production efficiency is to be improved, more expensive or toxic metals such as ruthenium, platinum, and cadmium must be used. Therefore, this traditional technology can no longer meet the modern environmental protection requirements, nor can it meet the demand for low cost.

Traditionally, there are methods available for producing hydrogen by electrolysis of water, and usually, renewable energy based electrical power technology is used to induce decomposition of water in order to produce hydrogen and oxygen. However, due to being highly energy-consuming and highly water-consuming, the production capacity can basically only produce 5% of hydrogen. In other words, the production efficiency of hydrogen production by electrolysis of water is quite limited and currently cannot meet the needs for industrialization. The current trend is to use excess wind power or solar photovoltaics to electrolyze water to produce hydrogen, and this considered to be the most standard “green hydrogen”, as only green energy is involved and carbon emission is low. However, its cost is still high, and there are still problems with transportation and storage, and consequently, it is still difficult to popularize.

The gas produced by steam reforming, in addition to hydrogen, often contains other products, which may cause other pollution and fail to meet environmental protection requirements. Therefore, the industry is looking for relevant solutions, and the development of hydrogen production technology must be applied in combination with environmental protection. Only by making full use of available resources can energy conservation be effectively achieved and developed and applied.

The production of hydrogen from aluminum has also been a hot topic in recent years, but the process involves adding aluminum to an alkaline aqueous solution to produce hydrogen and aluminum hydroxide. However, aluminum hydroxide produced in this way has a loose structure and low value, and requires a lot of energy to sinter into aluminum oxides at high temperature, which is costly and uneconomical. However, since this process can save the risk and cost of hydrogen transportation and storage, it is still the focus of industry attention.

### SUMMARY OF THE INVENTION

In view of the above, in order to improve the problems of the existing technology that the known way of production of hydrogen and nano metal oxides has high production costs, low safety, high carbon emissions, not meeting the requirements for environmental protection, and high storage costs and high transportation costs and risks, the present invention provides a method for manufacturing nano metal oxides and hydrogen, which comprises the following steps: Step A, providing a first reactor, and placing a metal material, an alcohol compound, and a first catalyst in the first reactor and applying heating thereto for reacting to generate a metal alkoxide compound, while simultaneously generating a substantial amount of hydrogen; and Step B, providing a second reactor, and, after the metal material in the first reactor has fully reacted in Step A, transferring remaining solution in the first reactor into the second reactor, and adding a second catalyst and a controlled amount of water, and applying appropriate heating to generate nano metal oxide in powder form. As such, effects of significant reduction of production cost, enhancement of safety, widespread application of hydrogen fuel cells, extremely low carbon emissions, being defined as “green hydrogen”, and reduction of storage costs and risks can be achieved.

### DETAILED DESCRIPTION OF THE PREFERRED EMBODIMENTS

The present invention provides, in a preferred embodiment, a method for manufacturing nano metal oxides and hydrogen, which mainly comprises the following steps:

Step A, providing a first reactor, and placing a metal material, an alcohol compound, and a first catalyst into the first reactor and applying heating thereto to generate a metal alkoxide compound, while simultaneously generating a substantial amount of hydrogen that is collected for use, so as to achieve an effect of producing hydrogen, wherein in this step, the metal material is one of zinc, aluminum, magnesium, titanium, silicon, vanadium, copper, iron, sodium, calcium, and potassium or an alloy or mixture of at least two thereof; in this step, the metal material is in the form of blocks, scraps, or powder, or is a waste from a metal refining process; in this step, the alcohol compound is one of methanol, ethanol, isopropanol, and n-butanol; and in this step, the first catalyst is one of metal chloride, bromide, fluoride, hydrochloric acid, bromic acid, and hydrofluoric acid.

Step B, providing a second reactor, and, after the metal material in the first reactor has fully reacted in Step A, transferring remaining solution in the first reactor into the second reactor, and adding a second catalyst and a controlled amount of water, and applying appropriate heating to generate nano metal oxide in powder form, so as to achieve an effect of producing nano metal oxide, wherein in this step, the second catalyst is an organic acid, such as acetic acid, oxalic acid, benzoic acid, and citric acid; and in this step, the nano metal oxide so generated has a particle size between 10-500 nanometers.

In Step B, after the nano metal oxide is generated, the alcohol compound in the second reactor can be distilled and collected, and then introduced back into the first reactor to serve as a raw material required for a next round of reaction.

When the metal material in the present invention is aluminum, the entire reaction formula is as follows:

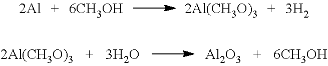

The net reaction formula is 2Al+3H₂O->Al₂O₃+3H₂

In this way, the metal material used in the present invention can be pure metal, alloy, recycled metal, cutting scraps, and smelting waste slag, which, as long as the metal content reaches 20-100%, can be completely reacted with the alcohol compound through catalysis by the catalyst to generate metal oxide precursors and hydrogen. The metal oxide precursor then reacts with water through a catalyst to form nano metal oxides and alcohol compound. The alcohol compound can be recycled as a raw material for the next round reaction, so that the process consumption is minimal.

As such, the present invention allows the production cost of nano metal oxides and hydrogen to be greatly reduced, and when used in conjunction with a hydrogen fuel cell, provides a system, which can produce hydrogen and generate electricity, for use in transportation without the need to carry a large amount of hydrogen, thereby avoiding safety concerns and high costs, and making the application of hydrogen fuel cells more popular. Moreover, the present invention does not involve use of petrochemical materials and does not emit carbon-containing gases, so that the carbon emissions are extremely low and the energy required is also small, and can thus be defined as “green hydrogen”. The hydrogen that is so produced can be compressed by using a compressor for storage in a hydrogen storage tank, or can be connected to a hydrogen fuel cell or for implementation of hydrogen internal combustion to directly generate electricity, reducing storage costs and risks. Such a way of direct electricity generation can be used in various means of transportation, such as trains, ships, buses, and cars. In this way, these vehicles will no longer need to carry large amounts of hydrogen, nor will there be need to set up expensive and unsafe hydrogen refueling stations, and it will only need to replenish metal materials (such as aluminum) and alcohol compounds. Finally, since the materials used in the present invention are highly safe and easy to transport, refueling stations can be widely set up to make hydrogen-powered transportation vehicles popular.

I claim:

1. A method for manufacturing nano metal oxides and hydrogen, comprising the following steps:
Step A, providing a first reactor, and placing a metal material, an alcohol compound, and a first catalyst in the first reactor and applying heating thereto for reacting to generate a metal alkoxide compound, while simultaneously generating a substantial amount of hydrogen; and
Step B, providing a second reactor, and, after the metal material in the first reactor fully reacts in Step A, transferring remaining solution in the first reactor into the second reactor, and adding a second catalyst and a controlled amount of water, and applying appropriate heating to generate nano metal oxide in powder form.

2. The method for manufacturing nano metal oxides and hydrogen according to claim 1, wherein in Step A, the metal material is one of zinc, aluminum, magnesium, titanium, silicon, vanadium, copper, iron, sodium, calcium, and potassium or an alloy or mixture of at least two thereof.

3. The method for manufacturing nano metal oxides and hydrogen according to claim 1, wherein in Step A, the metal material is in the form of one of block, scrap, or powder.

4. The method for manufacturing nano metal oxides and hydrogen according to claim 1, wherein the alcohol compound is one of methanol, ethanol, isopropanol, and n-butanol.

5. The method for manufacturing nano metal oxides and hydrogen according to claim 1, wherein in Step A, the first catalyst is one of metal chloride, bromide, fluoride, hydrochloric acid, bromic acid, and hydrofluoric acid.

6. The method for manufacturing nano metal oxides and hydrogen according to claim 1, wherein in Step B, the second catalyst is one of an organic acid, acetic acid, oxalic acid, benzoic acid, and citric acid.

7. The method for manufacturing nano metal oxides and hydrogen according to claim 1, wherein in Step B, the nano metal oxide in powder form has a particle size between 10-500 nanometers.

8. The method for manufacturing nano metal oxides and hydrogen according to claim 1, wherein in Step B, after the nano metal oxide is generated, alcohol compound in the second reactor is distilled and collected, and then introduced back into the first reactor to serve as a raw material for a next round of reaction.

9. The method for manufacturing nano metal oxides and hydrogen according to claim 1, wherein when the metal material is aluminum, reaction formulas are as follows:

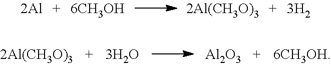

10. The method for manufacturing nano metal oxides and hydrogen according to claim 1, wherein when the metal material is aluminum, a net reaction formula is 2Al+3H₂O->Al₂O₃+3H₂.
